(19) United States
(12) Patent Application Publication
(10) Pub. No.: US 2010/0294281 A1
(43) Pub. Date: Nov. 25, 2010

(54) RESPIRATORY FACE MASK

(75) Inventor: Peter Chi Fai Ho, Pittsburgh, PA (US)

Correspondence Address: PHILIPS INTELLECTUAL PROPERTY & STANDARDS, P.O. BOX 3001, BRIARCLIFF MANOR, NY, 10510, US

(73) Assignee: RIC INVESTMENTS, LLC, WILMINGTON, DE (US)

(21) Appl. No.: 12/863,264

(22) PCT Filed: Jan. 20, 2009
(86) PCT No.: PCT/IB09/50200

§ 371 Date: Jul. 16, 2010

Related U.S. Application Data
(60) Provisional application No. 61/022,658, filed on Jan. 22, 2008.

(51) Int. Cl. A62B 18/08

(52) U.S. Cl. 128/206.24

(57) ABSTRACT

A mask assembly (10) is provided for delivering gas to a patient that includes a mask body (12) and a breathing circuit interface (16). The mask body includes an opening (13) for reception of the gas and includes a seal structure (20) for sealingly engaging with the face of the patient and surrounding at least the nose and mouth of the patient. The breathing circuit interface includes a first portion (17) rotatably connected with the mask body and a second portion (19) that is constructed and arranged to releasably connect with a conduit (18) for delivering the gas to the patient through the opening.

This application claims priority to U.S. patent application No. 61/022,658 filed 22 Jan. 2008, the entire contents of which are incorporated herein by reference.

### BACKGROUND OF THE INVENTION

1. Field of the Invention

The present invention relates to therapeutic gas delivery systems and, more particularly, to a mask having a cushion that forms a seal with a patient's face during gas delivery.

2. Description of the Related Art

A pleated cushion of a respiratory face mask is known (e.g., see U.S. Pat. No. 7,237,551 B2) provides an effective seal between an user and the face mask. Some face masks provide a cushion containing a gel to vary certain sealing or comfort characteristics of the mask (e.g., see U.S. Pat. Nos. 5,647,357; 5,884,624; and 6,397,847 B1). The present invention provides several embodiments and improvements over the prior art.

### SUMMARY OF THE INVENTION

One aspect of the present invention provides a cushion for use in a respiratory mask. The cushion includes a flap portion that is formed from a resilient material; a mid portion that is adjacent to the flap portion and is formed from the resilient material; and a connection portion that is adjacent to the mid portion and is formed from the resilient material. The cushion includes a pleat formed about a portion of the cushion, where the cushion has an apex region, a pair of side regions extending from the apex region, and a bottom region interconnected between the pair of side regions. The pleat extends continuously about the bottom region and at least a portion of the side regions, and the pleat extends discontinuously about the apex region. The apex region includes two apex pleats, where each apex pleat is interconnected to the adjacent corresponding side pleat, and the apex pleats are not interconnected to each other. The pleat at least partially defines a space, and the space is at least partially filled with a compliant material.

Another aspect of the present invention provides a cushion for use in a respiratory mask. The cushion includes a flap portion formed from a resilient material; and a connection portion that includes a resilient material and is interconnected with the flap portion. The connection portion defining a space or at least a portion of a boundary around the space, and a compliant material disposed in the space.

Another aspect of the present invention provides a cushion for use in a respiratory mask. The cushion includes a flap portion; and a connection portion that includes a resilient material and is interconnected with the flap portion. The flap portion includes a resilient material shaped to define a wall having a wall surface, where the wall surface is constructed and arranged to engage the face of a user. The flap portion defining a space, where the space is at least partially defined by the wall. A compliant material is disposed within the space.

Another aspect of the present invention provides a respiratory mask for use in delivering gas to a user. The respiratory mask includes a shell and a cushion, where the shell has a coupling constructed and arranged to be connected with a conduit, and the cushion. The cushion is coupled to the shell and is constructed and arranged to engage with the face of the a patient. The cushion includes a flap portion formed from a resilient material; and a connection portion interconnected with the flap portion and formed from the resilient material. The connection portion connected with the shell. A forehead engaging structure extending away from the shell, where the forehead engaging structure comprises a resilient material at least partially defining a space, and a compliant material is disposed with the space.

Another aspect of the present invention provides a respiratory mask for use in delivering gas to a user through a conduit. The respiratory mask includes a shell and a cushion, where the shell has a coupling constructed and arranged to be connected with a conduit, and the cushion. The cushion is coupled to the shell and is constructed and arranged to engage with the face of the a patient The cushion includes a flap portion formed from a resilient material; a mid portion adjacent the flap portion and formed from the resilient material; and a connection portion adjacent the mid portion and formed from the resilient material. The cushion also includes a pleat formed about a portion of the cushion, where the cushion has an apex region, a pair of side regions extending from the apex region, and a bottom region interconnected between the pair of side regions. The pleat extends continuously about the bottom region and at least a portion of the side regions, and the pleat extends discontinuously about the apex region. The apex region includes two apex pleats, where each apex pleat is interconnected to the adjacent corresponding side pleat, and the apex pleats are not interconnected to each other. The pleat at least partially defines a space, and wherein the space is at least filled with a compliant material.

Another aspect of the present invention provides a respiratory mask for use in delivering gas to a user through a conduit. The respiratory mask includes a shell and a cushion, where the shell has a coupling connected to the conduit and the cushion is coupled to the shell. The cushion includes a connection portion that connects the cushion to the shell; and a flap portion that is interconnected with the connection portion and is formed from the resilient material. The connection portion includes the resilient material shaped to define a space or at least a portion of a boundary around the space, and a compliant material disposed in the space

Another aspect of the present invention provides a respiratory mask for use in delivering gas to a user through a conduit. The respiratory mask includes a shell and a cushion, where the shell has a coupling connected to the conduit and the cushion is coupled to the shell. The cushion includes a connection portion that connects the cushion to the shell and is formed from the resilient material; and a flap portion that is interconnected to the connection portion. The flap portion includes the resilient material shaped to define a wall having a wall surface, the wall surface constructed and arranged to engage the face of a user. The flap portion defining a space, where the space is at least partially defined by the wall. A compliant material disposed within the space.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a side elevational view of the respiratory mask in accordance with an embodiment of the present invention;

FIG. 2 is a bottom plan view of the respiratory mask and a schematic view of a conduit and a positive airway pressure device in accordance with an embodiment of the present invention;

FIG. 3A is a front elevational view of a cushion of the respiratory mask in accordance with an embodiment of the present invention;

FIG. 3B is a side elevational view of the cushion in accordance with an embodiment of the present invention;

FIG. 4A is a top plan view of the cushion in accordance with an embodiment of the present invention;

FIG. 4B is a bottom plan view of the cushion in accordance with an embodiment of the present invention;

FIG. 5 is a side cross-sectional view taken through the line 5-5 of FIG. 3 and showing the cushion in accordance with an embodiment of the present invention;

FIG. 6 is a cross-sectional view taken through the line 6-6 of FIG. 3 and showing the cushion in accordance with an embodiment of the present invention;

FIG. 7 is a cross-sectional view taken through the line 7-7 of FIG. 3 and showing the cushion in accordance with an embodiment of the present invention;

FIG. 8 is a cross-sectional view taken through the line 8-8 of FIG. 3 and showing the cushion in accordance with an embodiment of the present invention;

FIG. 9 is a cross-sectional view taken through the line 9-9 of FIG. 3 and showing the cushion in accordance with an embodiment of the present invention;

FIG. 9A is a cross-sectional view of the cushion with a compliant material filled pleat in accordance with an embodiment of the present invention;

FIG. 9B is a cross-sectional view of the cushion with a compliant material filled pleat in accordance with another embodiment of the present invention;

FIG. 10A is a top perspective view of a cushion used in a nasal mask in accordance with an embodiment of the present invention;

FIG. 10B is a bottom perspective view of the cushion used in a nasal mask in accordance with an embodiment of the present invention;

FIG. 11 is a side elevational view of the cushion used in a nasal mask in accordance with an embodiment of the present invention;

FIG. 12 is a front perspective view of a cushion used in a nasal pillow in accordance with an embodiment of the present invention;

FIG. 13 is a rear perspective view of the cushion used in the nasal pillow in accordance with an embodiment of the present invention;

FIG. 14 is a side elevational view of the cushion used in the nasal pillow in accordance with an embodiment of the present invention;

FIG. 15 is a front elevational view of the cushion used in the nasal pillow in accordance with an embodiment of the present invention;

FIG. 16 is a top plan view of the cushion used in the nasal pillow in accordance with an embodiment of the present invention;

FIG. 17 is a cross-sectional view taken through the line 19-19 in FIG. 16 and showing the cushion used in the nasal pillow in accordance with an embodiment of the present invention;

FIG. 18 is a cross-sectional view of a mask having a cushion with a compliant material filled flap portion in accordance with an embodiment of the present invention;

FIG. 19 is a cross-sectional view of a mask having a cushion with a compliant material filled double flap portion, and a pleat in accordance with an embodiment of the present invention;

FIGS. 20A-C is a cross-sectional view of the compliant material filled double flap portion in accordance with an embodiment of the present invention;

FIG. 21 is a partial cross-sectional view of a mask with a cushion having a pleat and a compliant material filled connection portion in accordance with an embodiment of the present invention;

FIG. 22 is a side perspective view of a mask having a compliant material filled forehead support in accordance with an embodiment of the present invention;

FIG. 23 is a rear perspective view of the mask having a compliant material filled forehead support in accordance with an embodiment of the present invention;

FIG. 24 is a cross-sectional view of a mask with a connection portion and a forehead support both filled with a compliant material in accordance with an embodiment of the present invention;

FIG. 25 is a cross-sectional view of a mask with a connection portion and a forehead support both filled with a compliant material in accordance with another embodiment of the present invention.

FIG. 26 is a partial cross-sectional view of a mask having a cushion with a connection portion and flap portion both filled with a compliant material in accordance with an embodiment of the present invention;

FIG. 27 is a partial cross-sectional view of a mask with cushion comprising a connection potion, pleat, and flap portion each filled with a complaint material in accordance with an embodiment of the present invention;

FIG. 28A is a perspective view of a shell in accordance with an embodiment of the present invention;

FIG. 28B is a perspective view of a cushion in accordance with an embodiment of the present invention; and

FIG. 29 is a partial perspective view of a cushion in accordance with an embodiment of the present invention.

### DETAILED DESCRIPTION OF THE EXEMPLARY EMBODIMENTS

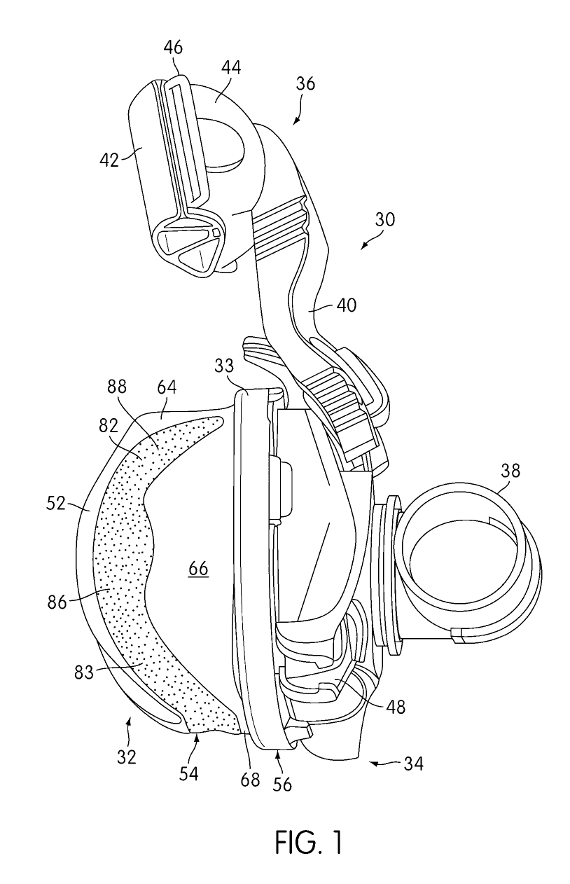

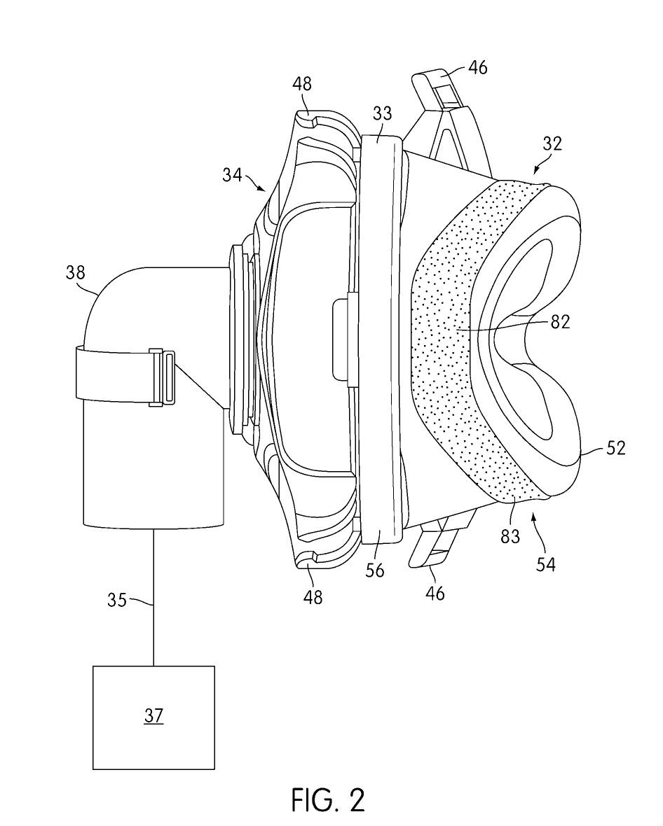

FIGS. 1 and 2 show a respiratory mask 30 for use in delivering gas to a user through a conduit 35 in an embodiment of the present invention. In one embodiment, respiratory mask 30 may generally include a shell 34 and a cushion 32, where the shell 34 has a coupling 38 connected to the conduit 35, and the cushion 32 is coupled to the shell 34. The cushion 32 includes a flap portion 52 formed from a resilient material; a mid portion 54 adjacent to the flap portion 52 and is formed from the resilient material; and a connection portion 56 adjacent to the mid portion 54 and is formed from the resilient material. The cushion 32 also includes a pleat 82 formed about a portion of the cushion 32. The cushion 32 has an apex region 64, a pair of side regions 66 extending from the apex region 64, and a bottom region 68 interconnected between the pair of side regions 66. The pleat 82 extends continuously about the bottom region 68 and at least a portion of the side regions 66 or the pleat 82 may extend discontinuously about the apex region 64, as shown. As seen in FIG. 1, the apex region 64 includes two apex pleats 88, where each apex pleat 88 is interconnected to the adjacent corresponding side pleat 86, and the apex pleats 88 are not interconnected to each other. Or, in a different embodiment, the pleat 82 may extend continuously about the entire cushion where the pleat 82 is at least partially filled with a compliant material 83 other than the resilient material.

In an embodiment, the cushion 32 of the respiratory mask 30 is attached to the shell 34 by a capture ring 33. The capture ring 33 fits about the cushion 32 and connects to the shell 34 to capture a portion of the cushion 32 between the capture ring 33 and the shell 34. The cushion 32 may be formed of any suitable material. The cushion 32 may be formed from a resilient material, such as silicone or any other elastic material as would be appreciated by one skilled in the art. Such different materials can be used for any of the cushions or pillows disclosed herein. The shell 34 is formed from a rigid plastic material, such as polycarbonate or any other plastic material as would be appreciated by one skilled in the art. Of course, the mask may be attached to the shell in a variety of other manners via adhesives, mechanical clips. Alterantively, the mask and shell could be integrally molded together or overmolded.

The respiratory mask 30, in one embodiment, may also include a forehead support 36 and the coupling 38 connected to the shell 34. The conduit 35 is connected to the respiratory mask 30 via the coupling 38. The conduit 35 delivers pressurized gas produced by a positive pressure device 37 to the respiratory mask 30. The positive pressure device 37 may create pressurized gas in any of a number of commonly known methods such as continuous positive pressure, variable pressure (such as a bi-level pressure that varies with the patient's respiratory cycle), or an auto-titrating pressure that varies with the monitored condition of the patient. As shown in FIG. 1, the forehead support 36 has a frame 40 that extends away from the shell 34. The frame 40 is attached to the shell 34 at one end and supports a pad 42 at the other end. Between the pad 42 and the frame 40 there is a rigid base 44. The respiratory mask 30 is held in place on a user's face by headgear (not shown). The headgear is connected to the forehead support 36 by ears 46 extending from the base 44. Similarly, the shell 34 has slots 48 adapted to receive pivot members, not shown, which are connected to the headgear. Together, the ears 46 and the slots 48 secure the headgear to the respiratory mask. The pad is flexible so that it can conform to the particular shape of the user's forehead.

As seen in FIG. 2, coupling 38 is an elbow connector 50 that is directed substantially coplanar with the shell 34 so that the attached conduit does not extend directly perpendicular from the shell 34. One of ordinary skill in the art can best appreciate that having a conduit which extends perpendicularly from the respiratory mask would place increased pressure on the mask and may also prove to be unwieldy. The elbow connector 50 is pivotably connected to the shell 34 so that as the user moves about the conduit may also freely move through a pivoting action.

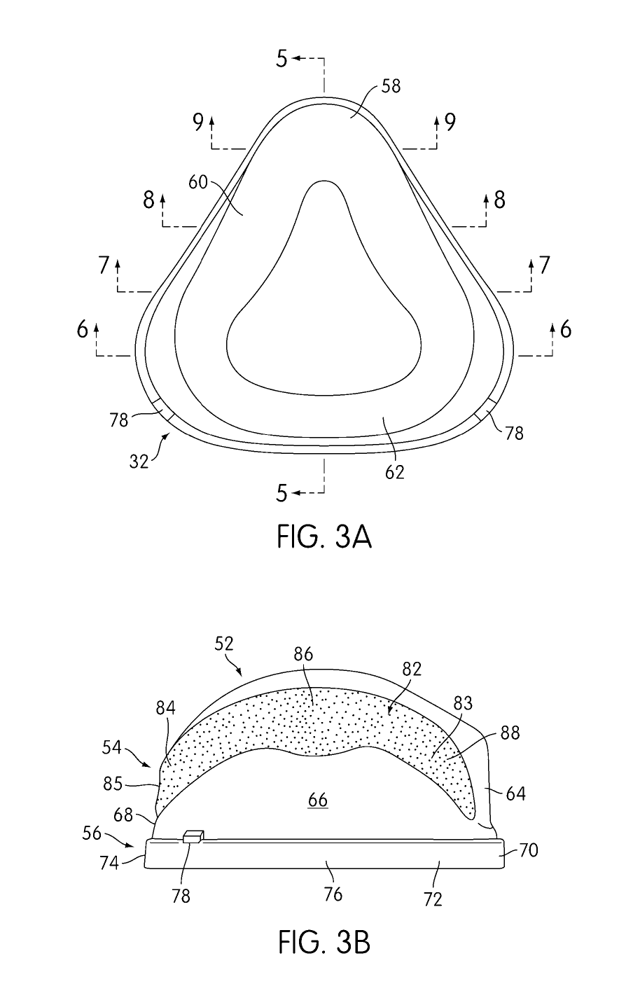

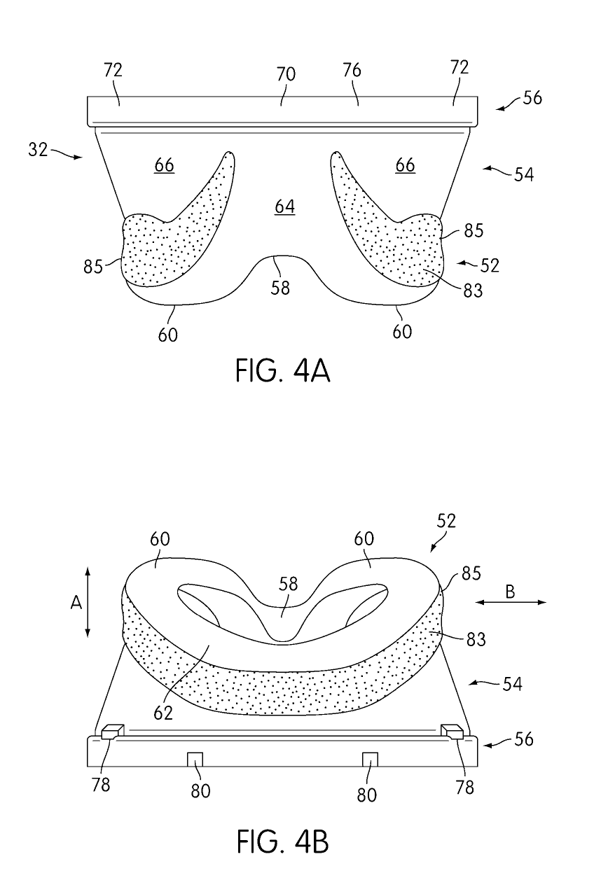

As shown in FIGS. 3A, 3B, 4A, and 4B, the cushion 32 has a generally triangular-shaped periphery and fits over the user's nose. The cushion 32 is configured to provide a flexible seal between the user and the shell 34. In order to be effective, the cushion 32 should be comfortable, otherwise patient compliance would be reduced. In addition, the cushion 32 should also provide a substantially leak-free seal between the user and the shell 34.

The cushion 32, in one embodiment, has the flap portion 52, the middle portion 54, and the connection portion 56. Each portion is specifically configured to achieve different goals. The flap portion 52 is configured to provide a secure seal between the user and the shell 34. The middle portion 54 is configured to provide support to the cushion 32 to resist the forces exerted upon the cushion 32, although as shown herein, some embodiment substantially do away with the middle portion. The connection portion 56 is designed to provide a secure connection between the cushion 32 and the shell 34.

In one embodiment, each portion of the cushion 32 has an apex region, a pair of side regions, and a bottom region. For example, the flap portion 52 shown in FIGS. 1-9 has an apex flap 58 adjacent a pair of side flaps 60. The side flaps 60 are joined by a bottom flap 62 to form a substantially triangular-shaped flap portion. The apex flap in some of the embodiments disclosed herein may be generally configured to seal against the nose of the user, while the side flaps and the bottom flap may be generally configured to seal against the cheeks (or side of the face) and chin, respectively. The middle portion 54 is adjacent to the flap portion 52. As discussed earlier, the middle portion 54 has the middle apex region 64 adjacent the pair of middle side regions 66. The middle side regions 66 joined together by the middle bottom region 68. Lastly, the connection portion 56 is an apex connection region 70 adjacent a pair of connection side regions 72. The connection side regions 72 are adjacent a connection bottom region 74. The connection portion 56 has a collar 76 which may be captured between the shell 34 and the capture ring 33 to form a substantially hermetic seal with the shell 34. Extending from the collar 76 is a pair of alignment projections 78 and alignment slots 80. Together the alignment projections 78 and the alignment slots 80 act to prevent the cushion 32 from being misaligned relative to the shell 34.

Another aspect of this exemplary embodiment of the present invention is the incorporation of the pleat 82 as best appreciated with reference to FIGS. 3B and 4B. The pleat 82 extends about a portion of the cushion 32. The pleat 82 is filled with a compliant material 83 that is different than the resilient material from which the cushion 32 is formed. In one embodiment, the compliant material 83 is silicone gel. In another embodiment, the compliant material 83 may be selected from the group consisting of gel (e.g., super soft silicone gel), gas, liquid (where “liquid” is referred to herein as the compliant material, it is contemplated that any appropriate liquid may be used, such as water, chemically treated water (e.g., treated for pH)), foam, non cross-linked polymer, or saline, for example. Where the compliant material is a gas, it is contemplated that any appropriate gas may be used. In one embodiment, the gas may be an inert gas, such as air, or nitrogen. The compliant material 83 may be retained within the pleat 82 by silicone coating 85, or silicone spray 85, both silicone spray and silicone coating or any other material that can perform a sealing function.

The pleat 82 provides an integral corrugation, which provides a spring-type action perpendicular to the pleat 82 as indicated by double arrow A. In combination with the varied wall thickness, this feature allows the spring to become progressively stiffer as it is compressed. The incorporation of the compliant material 83 into the pleat 82 may dampen and/or delay the spring movement. This dampening and/or delaying action provided by the compliant material may exist with each of the regions provided with a compliant material as disclosed herein in the various embodiments.

The pleat 82 is located adjacent to the flap portion 52 and extends inwardly. As pressure is applied to the flap portion 52, it will ultimately abut against the compliant material filled pleat 82 and become more rigid. In the event that multiple pleats filled with compliant material 83 are used, this feature can provide progressively increasing resistance as the pressure is increased. Therefore, at the option of the user, the amount of resistance provided by the cushion 32 may be varied. In addition to the corrugation, by deforming and rolling in, the compliant material filled pleat 82 keeps the user in contact with the compliant material 83 through layers of the flap portion 52, thus, enhancing the conformity of the seal to the user's face.

The use of pleats also simultaneously makes the cushion 32 more rigid in the off-axis direction indicated by double arrow B. This allows the cushion 32 to resist radial forces applied parallel to the pleat 82. The depth of pleat 82 may be deepened to provide a more elastic region or the number of pleats could be increased to further enhance these effects. In other regions, the pleat 82 may be comparatively shallow or completely removed from some regions to reduce this effect. In each of the embodiments disclosed herein, the amount of gel (or other compliant filler material) can be altered at different regions to specifically adjust the spring dampening characteristics at different portions of the pleat 82.

In the embodiments disclosed herein, wherein it is stated that the compliant material is of a different material than the material of the cushion itself, this means only that the compliant material has a different resiliency than that of the cushion material. For example, it is contemplated that both the cushion material and the compliant material may be formed from a silicone based material, but with the composition of the cushion silicone being different from the compliant material silicone filler (e.g., different hardness, different viscosities, different phase and/or different chemical compositions). In addition, in each embodiment disclosed herein, the compliant material may have two different materials or components (e.g., liquid and gel), as will be appreciated from later discussions herein.

The pleat 82, which is a discontinuous structure in one embodiment, has the bottom pleat (or pleat region) 84 which extends around the mid bottom region 68 and the pair of side pleats (or pleat regions) 86 which extend up the mid side regions 66. Finally, the pleat 82 turns towards the connection portion 56 and terminates with the pair of apex pleats (or pleat regions) 88. The apex pleats 88 are not interconnected. Instead, the apex pleats 88 terminate short of each other. The pleats 82 extends about the cushion 32 proximate the flap portion 52 which allows the pleat 82 to be more responsive to forces exerted in this region of the cushion 32. Namely, the pleat 82 is more responsive to forces exerted on the flap by the user's face in direction A than by forces exerted radially inwardly on the cushion 32 in the direction indicated by arrow B, as seen in FIG. 4B. Alternatively, the pleat 82 could be located in other regions of the cushion 32 to be more responsive to the forces exerted in these other regions of the cushion 32.

One of ordinary skill in the art can best appreciate that the pleat 82 may vary in the distance that it deviates. The pleat 82 is shown extending inwardly; however, the pleat 82 could also extend radially outwardly without departing from the teachings of the present invention. Having the pleat 82 extend inwardly reduces the overall size of the cushion. Moreover, having the pleat 82 extend inwardly minimizes the possibility that external items could be pinched within the pleat 82. The height of the pleat 82 may also be varied to adjust the strength provided by the pleat 82.

As shown in the exemplary embodiment, the pleat 82 has a generally smoothly curved configuration. However, the term “pleat” as used herein should be broadly interpreted to include any feature, which deviates from a substantially planar region surrounding the pleat 82. For instance, the present invention also contemplates that the pleat 82 may have a variety of cross-sectional configurations including a smoothly curved cross-section or creased into a jagged saw-tooth or rectangular cross-section. As shown in the first exemplary embodiment, the pleat 82 is shown as a single pleat. However, the present invention also contemplates that multiple pleats may be placed adjacent to one another.

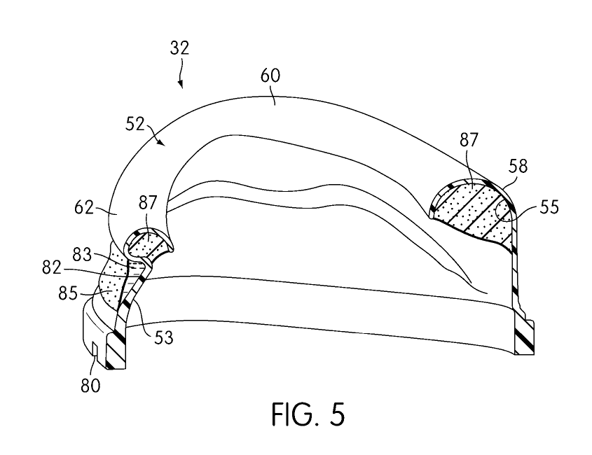

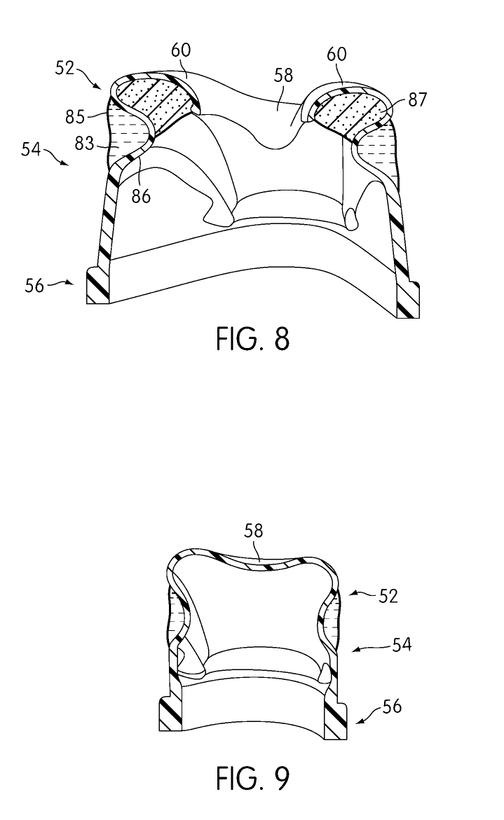

As seen in FIGS. 5 and 8, the apex flap 58, side flaps 60, and bottom flap 62 have lengths which vary between each region. Looking at the cross-section, it can be best appreciated that the flaps extend away from the middle portion in a cantilevered manner. By altering the length of the flaps, the moment arm can be varied in different regions. For example, the apex flap 58 may have a comparatively long length compared to the bottom flap 62 with the side flaps 60 having a length which transitions between the two. Providing the apex flap 58 with a longer length permits this flap to be comparatively more deformable so that it can properly seal against the rapidly changing geometry about the bridge of the user's nose. In contrast, the bottom flap 62 is comparatively shorter. In this region of the user's face, the geometry of the user's face changes very slowly. Therefore, it is not necessary to have as deformable a flap as is needed in the apex region. Instead more support is needed in this region. Therefore, a flap with a shorter length is utilized.

FIG. 5 shows a cross-sectional view of the cushion 32 with the pleat 82. The compliant material 83 is filled in the pleat 82 and is retained within the pleat 82 by silicone spray 85, or silicone coating 85, both silicone coating and silicone spray or other compliant sealant material. In another embodiment, as shown, gel 87 may optionally be provided inside the flap portion 52, specifically, under the pair of side flaps 60 and/or the bottom flap 62. As will be appreciated from more detailed discussions later, the gel 87 may be retained by a second wall that adhesively engages with a wall of the flap portion 52. In contrast to the previous embodiments, where the compliant material 83 is in contact with the exterior surface 53 of the cushion 32, the gel 87 filled inside the flap portion 52 is shown in contact with the interior surface 55 of the cushion 32. The flap portion 52 may have an arcuate cross-section, taking a concavo-convex or “C” shaped configuration. The gel 87 is disposed within the space defined on the concave side of the configuration of the flap portion 52. In another embodiment, not shown, the gel in the flap portion is on the exterior surface of the cushion (e.g., on the convex side) and is sealed or separated from the patient's face only by a silicone coating or spray seal. In each of the embodiments disclosed herein, the amount of gel (or other compliant filler material) can be altered at different regions to control the spring dampening characteristics at different portions of the flap portion 52.

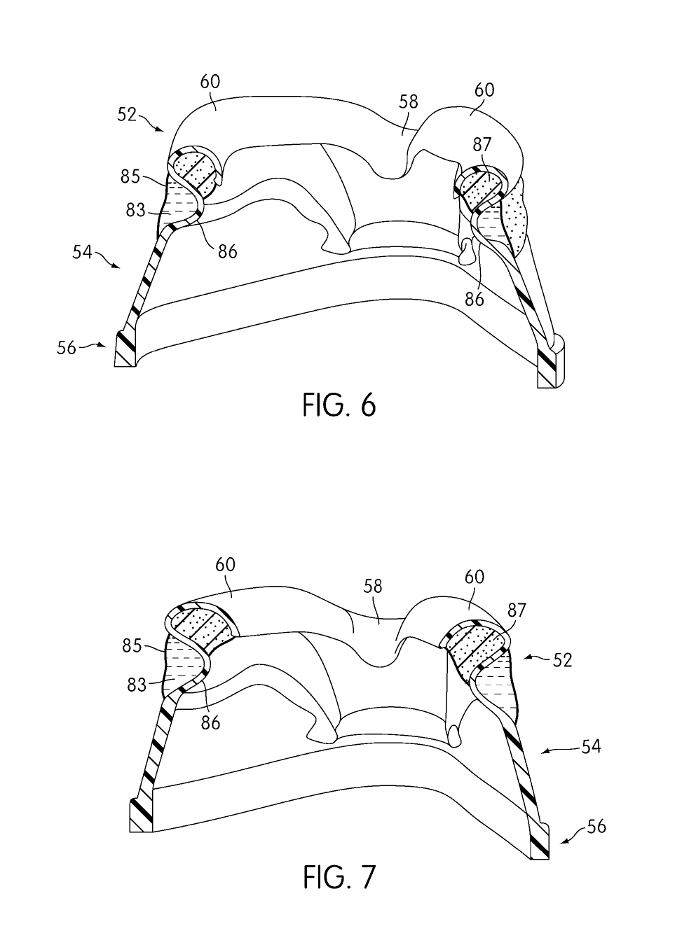

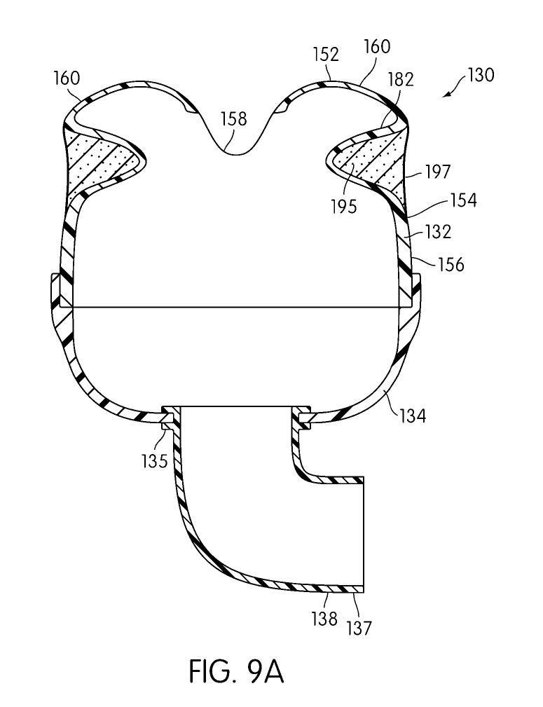

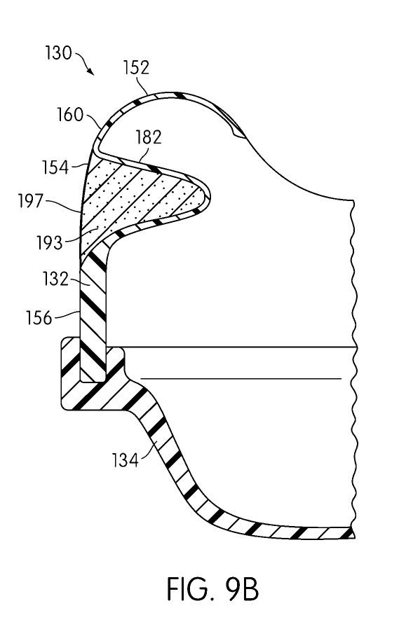

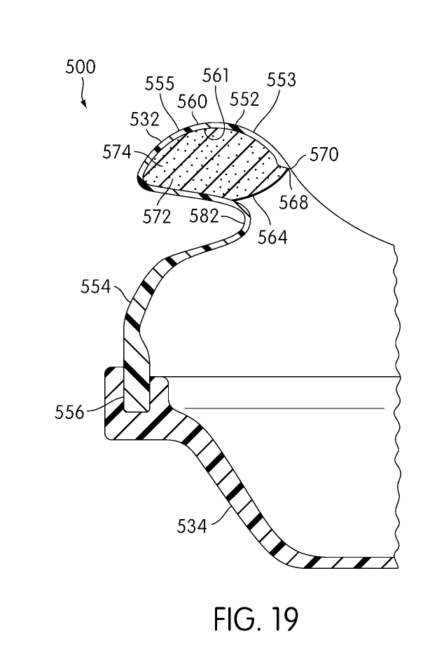

FIGS. 6-9 show different cross-sectional views of the cushion 32 as shown in FIG. 3A. The side pleats 86 shown in FIGS. 6 and 7, which extend up the middle portion 54, gradually terminate with the pair of apex pleats 88, as shown in FIG. 8. By comparing the pleat 82 in FIGS. 8 and 9, it can be clearly seen that the depth of the apex pleats 88 gradually decreases as they move towards the mid apex region 64 (see FIG. 4A). The apex pleats 88 are not interconnected and instead, the apex pleats 88 terminate short after each other. Therefore, as discussed above, the pleat 82 of the cushion 32 has a discontinuous structure. As discussed in the previous embodiments, the pleat 82 is filled with the compliant material 83 and may be retained within the pleat 82 by silicone spray 85, or silicone coating 85, both silicone coating and silicone spray or other compliant sealant material. In another embodiment, the gel 87 may alternatively, or additionally, be filled inside the flap portion 52, specifically, under the pair of side flaps 60 and/or under the bottom flap 62 (see FIG. 5) and may be retained by the double wall, which will be described in detail with respect to FIG. 19, that adhesively engages with the wall of the flap portion 52.

With reference to FIGS. 6-9, the cross-sectional thickness of the flap portion 52, the middle portion 54, and the connection portion 56 may be seen. Generally, the wall thickness of each portion varies with the connection portion 56 being relatively thick. The middle portion 54 has a generally moderate wall thickness, and the flap portion 52 has a relatively thin wall thickness. The wall thickness of the connection portion 56 is relative thick in order to provide a secure interface with the shell 34. The middle portion 54 has a moderate wall thickness in order to provide adequate strength without wasting material. Finally, the flap region 52 has a comparatively thin wall thickness so that it may easily conform to the particular shape of the user's face. Of course, one skilled in the art can best appreciate that the wall thickness of these regions could be varied without departing from the teachings of the present invention.

FIG. 9A shows a cross-sectional view of the respiratory face mask 130, in another embodiment, for use in delivering gas to a user. The respiratory mask 130 includes a shell 134 and a cushion 132 connected to the shell 134. A coupling 138 is rotatably connected to the shell 134 at a rotatable connection 135 at one end thereof, and has an opposite end 137 adapted to be connected with a conduit (not shown) for delivering gas to the mask 130. The cushion 132 is formed from a resilient material and includes a flap portion 152, a mid portion 154 that is adjacent to the flap portion 152, and a connection portion 156 that is adjacent to the mid portion 154. Alternatively, mid portion 154 can be very short or non-existent. In one embodiment, the resilient material of the cushion 132 may be silicone or other elastic material as would be appreciated by one skilled in the art. The flap portion 152 of the cushion 132 has an apex flap 158, a pair of side flaps 160 extending from the apex flap 158, and a bottom flap (not shown) interconnected between the pair of side flaps 160. The cushion 132 also includes a pleat 182 formed about a portion of the cushion 132. The pleat 182 extends continuously about the bottom region and at least a portion of the side regions, and the pleat 182 extends discontinuously about the apex region, thus, making the pleat 182 a discontinuous pleat. The pleat 182 is at least partially filled with a compliant material 195 that is different than the resilient material of the cushion 132, and thus has different deformation characteristics than the cushion 132. The compliant material 195, in one embodiment, is formed from a gel material, such as silicone gel, and may be retained in the pleat 182 by a seal structure 197, such as silicone spray, or silicone coating, both silicone coating and silicone spray or any other sealant material.

FIG. 9B shows another embodiment similar to FIG. 9A, except the compliant material 193 comprises a liquid material, such as water or saline. The liquid material may be sealed by any compliant, resilient solid seal structure 197. In one embodiment, the seal structure 197 may be formed from silicone, as a coating or a spray, and in one embodiment the seal structure 197 may be integrally formed with other portions of the cushion 132 (e.g., as a flap), and is subsequently sealed after liquid material is inserted, such sealing of a flap or other structure can be accomplished by ultrasonic welding, heat, adhesives, etc. In another embodiment, seal structure 197 may be a separate structure (not integrally formed with the cushion 132) and subsequently applied and sealed. These broad principles and embodiments regarding the various possible arrangements of seal structure 197 equally applied to all compliant material retaining seal structures disclosed in all embodiments herein.

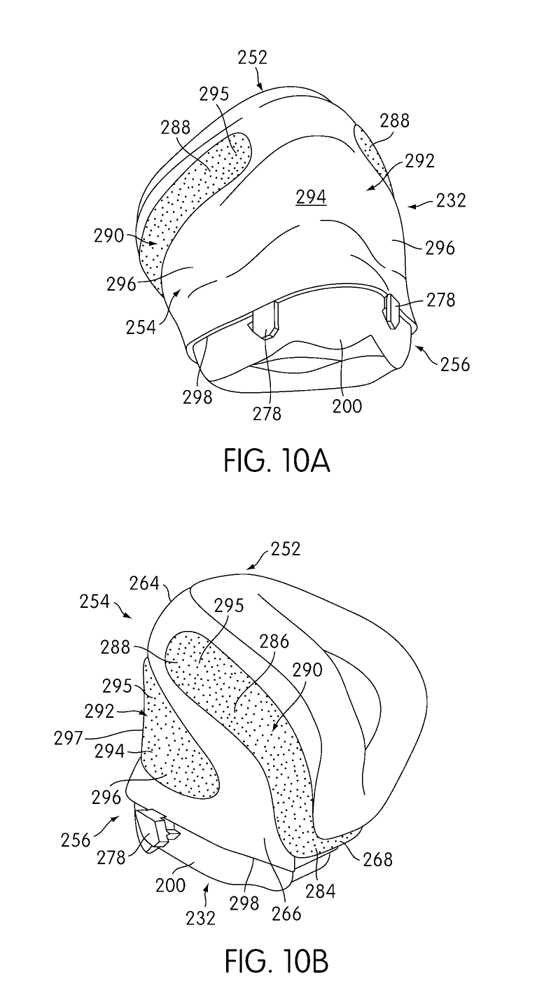

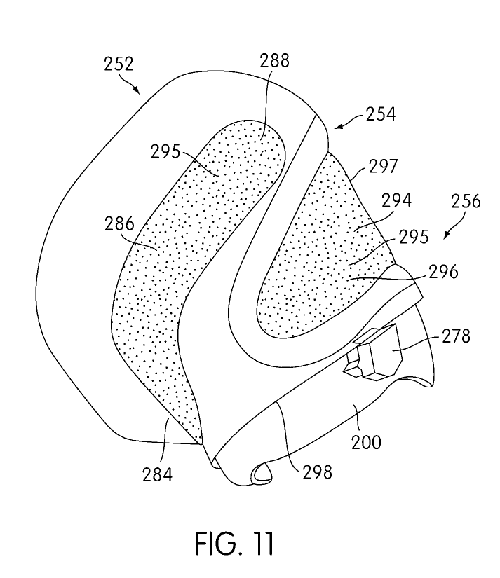

In yet another exemplary embodiment of the present invention, cushion 232 is shown in FIGS. 10A, 10B and 11 as a nasal mask for covering the user's nose. Once again, the cushion 232 may have a flap portion 252, a middle portion 254, and a connection portion 256. The cushion 232 has a first pleat 290 that extends about a portion of the cushion and a second pleat 292 which extends about another portion of the cushion. The first pleat 290 includes a bottom pleat (or pleat region) 284, a pair of side pleats (or pleat regions) 286, and a pair of apex pleats (or pleat regions) 288. Similarly, the second pleat 292 has an apex pleat 294 and a pair of side pleats 296. The cushion 232 may be formed of any suitable material. Preferably, the cushion 232 is formed from a resilient material, such as silicone or any other elastic material as would be appreciated by one skilled in the art.

The first pleat 290 and/or the second pleat 292 may be filled or at least partially filled with a compliant material 295, which compliant material is different from the resilient material of the cushion 232 as discussed previously. In the illustrated embodiment, both pleats 290 and 292 are shown provided with the compliant material 295. In one embodiment, the compliant material 295 is retained within the first pleat 290 or the second pleat 292 by a seal 297, which can take the form of one of the types of seal structures disclosed above. In one embodiment, the compliant material 295 may be selected from the group consisting of gel, gas, liquid, foam, non cross-linked polymer, or saline. The first pleat 290 includes two apex pleats 288, where each apex pleat 288 is interconnected to the adjacent corresponding side pleat 286, however, the apex pleats 288 are not interconnected to each other, thus, making the first pleat 290 discontinuous. The second pleat 292 includes two side pleats 296, where each side pleat 296 is interconnected to the apex pleat 294, however, the side pleats 296 are not interconnected to each other, thus, making the second pleat 292 discontinuous.

The second pleat 292 is shallower than the first pleat 290. Accordingly, the second pleat 292 is substantially more rigid than the first pleat 290 and thus more capable of resisting axially directed forces than the first pleat 290. However, the second pleat 292 is less rigid in the axial direction than if this region did not have a pleat at all. The first pleat 290 extends about the middle portion 254 and proximate the flap portion 252. One can appreciate that the strength modifications this pleat provides will be more responsive to forces exerted on the flap portion 252 than forces exerted on the connection portion 256. In contrast, the second pleat 292 extends about the middle portion 254 and proximate the connection portion 256. The second pleat 292 will be more responsive to forces exerted on the connection portion 256 than the flap portion 252. Together the first pleat 290 and the second pleat 292 exhibit one embodiment of the present invention utilizing the unique strength modifying characteristics of present invention. The first pleat 290 is more responsive to forces applied to the flap portion 252 and provides a region on increased flexibility about the mid bottom region and the mid side regions of the flap portion 252. This creates a hinging motion relative to the mid apex region of the cushion proximate the flap portion 252. The second pleat 292 is more responsive to forces exerted on connection portion 256 and provides a region of increased flexibility about the mid top region and mid side regions of the connection portion 256. This creates a hinging motion relative to the mid bottom region of the cushion 232 proximate the connecting portion 256.

The connection portion 256 of this exemplary embodiment also includes an alignment projection 278. Unlike the prior embodiment, connection portion 256 is formed having a shoulder 298 about step 200. However, the present invention can be utilized in a variety of masks with differing connection features. The cushion 232 is coupled to a shell, not shown.

Strategic placement of pleats 290 and 292 filled with the compliant material 295 will provide the cushion 232 with a hinge-like action. With reference to FIG. 10B, pleats 290 and 292 form a pair of integral hinges generally opposed to one another. Pleat 292 allows the middle apex region 264 and middle side regions 266 to flex easier than middle bottom region 268. Often with such cushions a conduit may extend outward at a variety of different angles. The second pleat 292 permits the cushion 232 to easily adapt as the angle between the cushion 232 and the conduit changes. The first pleat 290 allows middle side regions 266 and middle bottom region 268 to flex together easier than middle apex region 264. The first pleat 290 acts in a similar manner as pleat 82 in the previous embodiment which is more responsive to forces applied to the flap portion 252. The compliant material 295 may dampen the hinge-like action, depending on the amount and type of compliant material used.

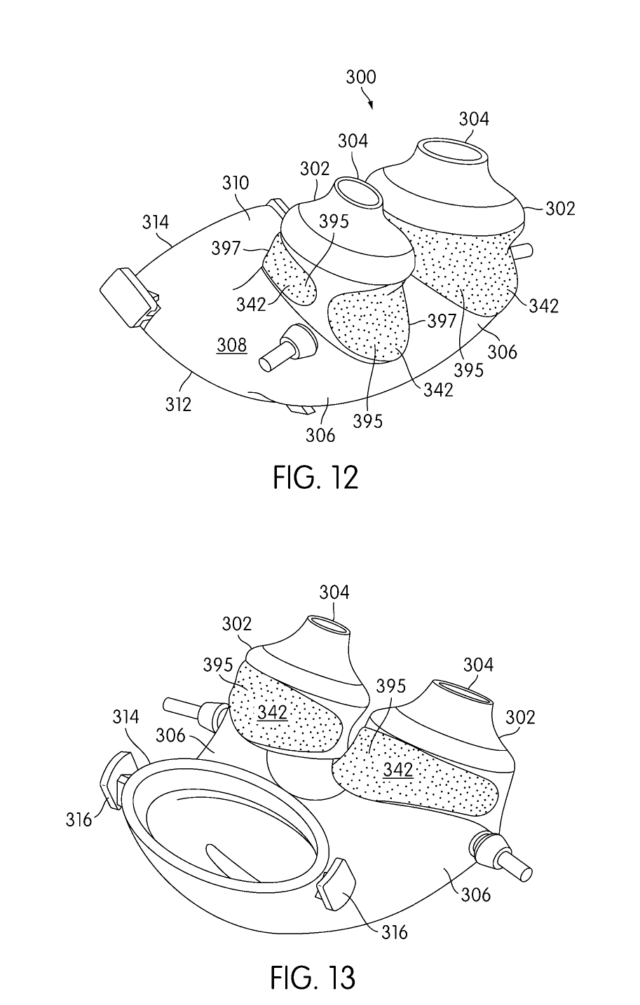

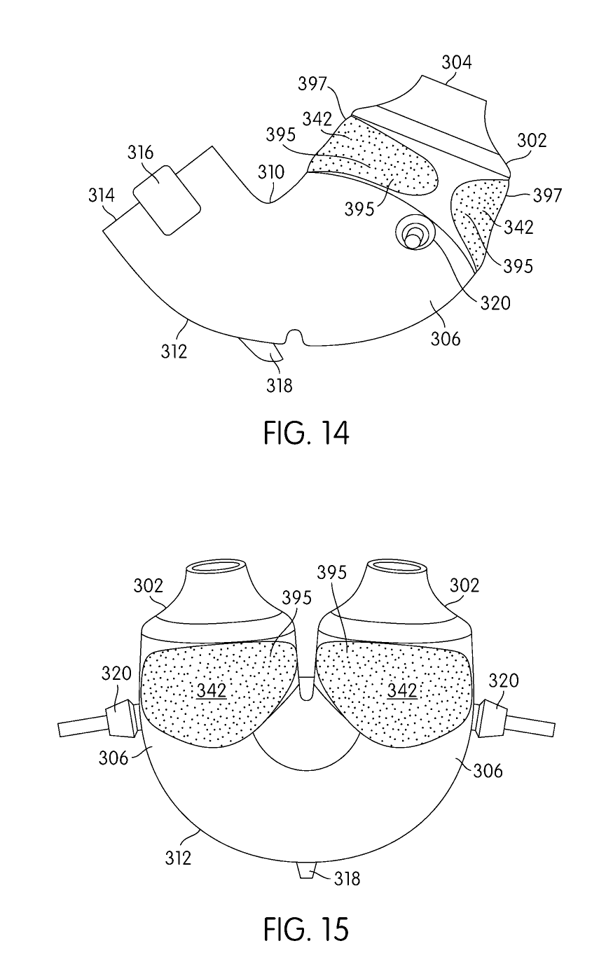

Another embodiment of the invention is shown in FIGS. 12-17 in which aspects of the present invention are incorporated into a nasal pillow 300. An exemplary nasal pillow is fully disclosed in U.S. patent application Ser. No. 10/918,832, the entire contents of which are hereby incorporated by reference herein. The nasal pillow 300 includes nare elements 302 terminating at an opening 304. Nare elements 302 are joined together by outlet legs 306 that merge together into body 308. Body 308 has an inner curved surface 310 and an outer curved surface 312 defining an internal cavity 313 therebetween. Body 308 terminates at an opening 314. As best appreciated with reference to FIGS. 13 and 14, the body also includes alignment rails 316, alignment fin 318, and bosses or mounting tabs 320. The nasal pillow 300 is made from a resilient material, such as silicone or any other suitable elastic material as would be appreciated by one skilled in the art.

Each nare element 302 includes at least one pleat 342 that extends around a portion of each nare element 302. As in the prior embodiments, the pleats 342 are at least partially filled with a compliant material 395, which is different from the resilient material of the nasal pillow 300. In one embodiment, the compliant material 395 is retained within the pleats 342 by a seal structure 397 of the type disclosed above. The pleats 342 are two pleats 342, which are not interconnected to each other, thus, making the pleats 342 discontinuous. The compliant material 395 may be formed from any of the materials discussed above for use as the compliant material.

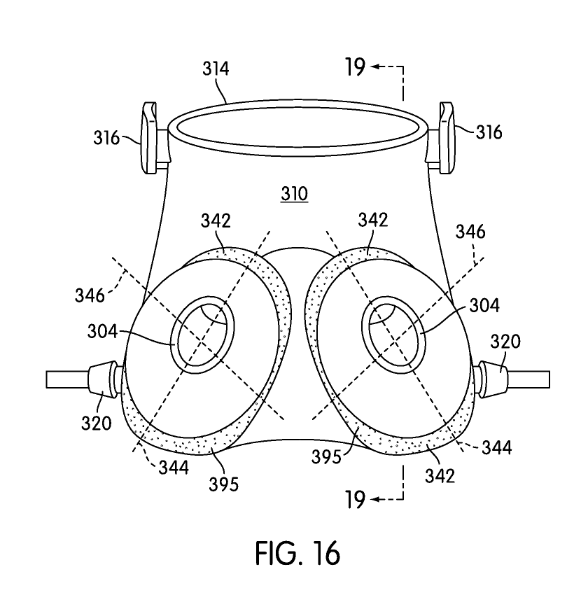

As in the prior embodiment, the pleats 342 filled with compliant material 395 permit the nare elements 302 to articulate in a controlled and dampened manner. For instance, the pleats 342 may be oriented with the region of deepest recess aligned where the most flexibility is desired. As best appreciated with reference to FIG. 16, each nare element has an approximately elliptical cross-section defining a major axis 344 and a minor axis 346 orthogonal to the major axis. Of course, the shape of the nares may have a variety of other shapes without departing from the scope of the present invention. The pleats 342 with the compliant material 395, in FIG. 16, are oriented such that the region with the deepest recess is approximately aligned with the major axis 344 of each nare element 302 and gradually become shallower towards the minor axis 346. This configuration permits the nare elements 302 to be more flexible and thus pivot along the major axis while simultaneously being relatively more rigid and resist bending along the minor axis 346.

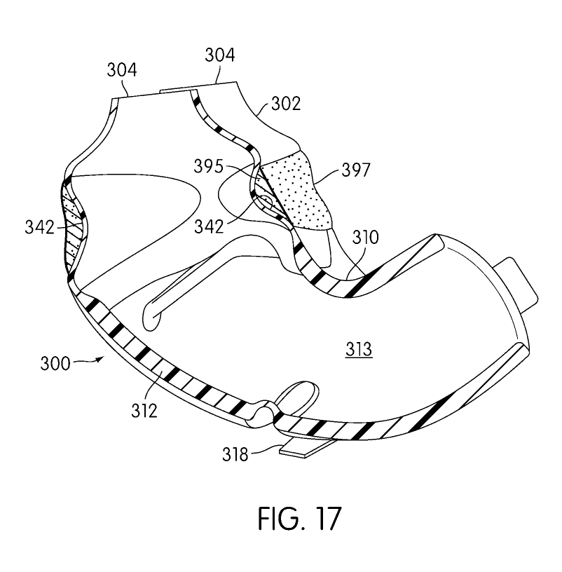

With reference to FIG. 17, the nare elements 302 may be further enhanced by forming pleats 342 with a thinner wall thickness in the region of deepest recess. This further permits the nare elements 302 to pivot as well as rotate. The nares may pivot along the major axis and/or rotate about their center in a controlled manner to accommodate the particular nasal configuration of different users. Of course, the pleats 342 filled with compliant material 395 may be placed in other locations about the nare elements 302 to promote localized, damped pivoting as deemed desirable without departing from the teachings of the present invention.

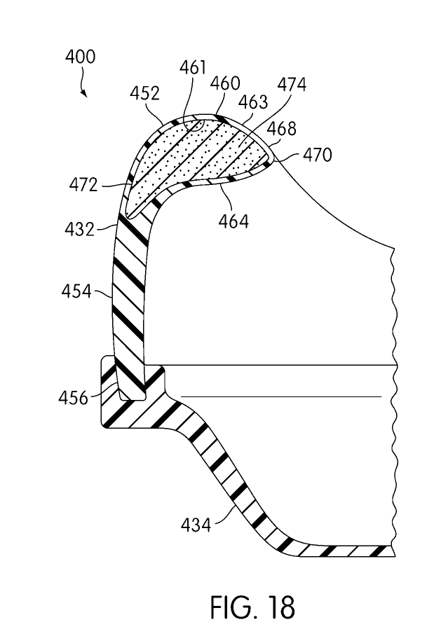

FIG. 18 illustrates an embodiment of a respiratory mask 400 having a cushion 432, where the cushion 432 includes a flap portion (or face contacting structure) 452 with a compliant material filled space 472. However, the cushion 432, in this embodiment, does not have a pleat formed about the cushion 432. The cushion 432 has the flap portion 452, a middle portion 454, and a connection portion 456. The middle portion 454 is adjacent to the flap portion 452. The connection portion 456 of the cushion 432 may be attached to the shell 434 using any method as discussed later. As shown in FIG. 18, the side flaps 460 of the flap portion 452 extending from the middle portion 454 bifurcate into a wall 461 and a second wall 464. The first outer wall 461 and the second inner wall 464 are constructed and arranged to adhesively connect with each other at their outer edges 468 and 470 respectively, such that the compliant material filled space 472 is formed between the wall 461 and the second wall 464. The wall 461 includes an outer wall surface 463 that is constructed and arranged to engage the face of the user.

In one embodiment, the outer edge 468 of the wall 461 is adhesively connected to the outer edge 470 of the second wall 464 using RTV adhesive. The compliant material filled space 472 is constructed and arranged to receive a compliant material 474, such as gel. The compliant material 474 in the compliant material filled space 472 virtually contacts the patient's face, only separated by the thin outer wall 461 of the cushion. This may enhance the comfort and conformability characteristics for the patient wearing the respiratory mask 400. In one embodiment, the compliant material 474 is a super soft silicone gel. In one embodiment, the compliant material 474 in the compliant material filled space 472 may extend through the entire periphery of the cushion 432, thus, forming a cushion with continuous compliant material filled flap portion. In an alternative embodiment, the compliant material 474 in the compliant material filled space 472 may be formed in discrete regions of the flap portion 452, thus, forming a cushion with discrete and discontinuous compliant material filled flap portion.

FIG. 19 illustrates an embodiment of a patient interface 500 having a cushion 532, where the cushion 532 includes a double flap structure forming a compliant material filled space 572 for receiving the compliant material. This embodiment includes a pleat 582 formed about the portion of the cushion 532. The cushion 532 has a flap portion (or face contacting structure) 552, a middle portion 554, and a connection portion 556. The middle portion 554 is adjacent to the flap portion 552. The connection portion 556 of the cushion 532 may be attached to the shell 534 using any method discussed later. The pleat 582 is between the flap portion 552 and the middle portion 554.

The flap portion 552 includes a wall 553 having a wall surface 555, where the wall surface 555 is constructed and arranged to engage with the face of the user or the patient. A second wall 564, located below the wall 553, is constructed and arranged to connect with the wall 553 of the flap portion 552 to form the sealed space 572 there between. Specifically, an outer edge 570 of the second wall 564 is connected (e.g., by adhesive) with an outer edge 568 of the wall 553 of the flap portion 552 such that the space 572 is formed between the wall 553 of the flap portion 552 and the second wall 564. In one embodiment, the outer edge 568 of the wall 553 of the flap portion 552 is adhesively connected to the outer edge 570 of the second wall 564 using RTV adhesive. The compliant material filled space 572 is constructed and arranged to receive the compliant material 574. The compliant material 574 in the compliant material filled space 572 virtually contacts the patient's face (only separated by wall 553) and enhances the comfort and conformability characteristics for the patient wearing the patient interface 500. As described in the previous embodiment, the compliant material 574, in this embodiment, also is in contact with the interior surface 561 of the cushion. In one embodiment, the compliant material 574 in the space 572 may extend through the entire periphery of the cushion 532, thus, forming a continuous compliant material filled flap portion. In an alternative embodiment, the compliant material 574 in the space 572 may be formed in discrete regions of the flap portion 552, thus, forming a discrete and discontinuous compliant material filled flap portion. The patient's face first contacts with the compliant material filled flap portion and compresses the compliant material filled flap portion. Then the pleat 582 gets into action to act as a support and conforms the flap portion to the patient's face by deforming and rolling (bulging) inwardly.

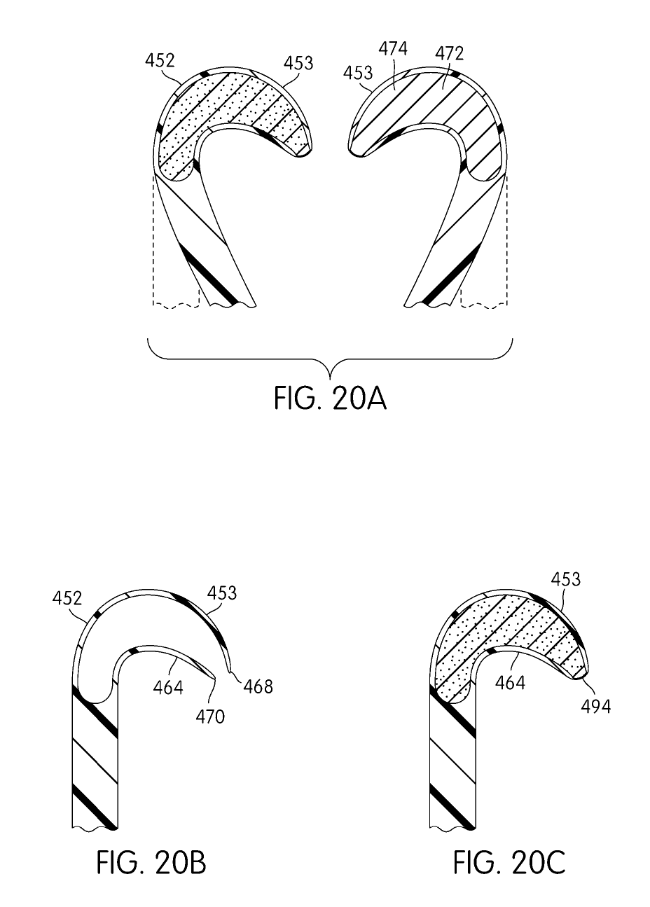

FIGS. 20A-20C show cross-sectional views of a flap portion 452 that is the same as or similar to the flap portion 452 of the respiratory face mask 400, which is discussed above with respect to FIG. 18. The flap portion 452 is molded as a double flap with a designed overlap for gluing to form the compliant material filled space 472 for receiving the compliant material 474. In detail, FIGS. 20B shows that the outer edge 468 of the wall 453 of the flap portion 452 extends beyond the outer edge 470 of the second wall 464. When the outer edge 468 of the wall 453 is being connected to outer edge 470 of the second wall 464, the outer edge 468 of the wall 453 engages the outer edge 470 of the second wall 464. As shown in FIG. 20C, the outer edge 468 of the wall 453 is adhesively connected to outer edge 470 of the second wall 464 by placing RTV adhesive 494 in the overlapping portion or mating of the outer edge 468 and outer edge 470. Alternatively, in one embodiment, the compliant material 474 can be injected into space 472 after the walls are sealed. This can be done by making a small hole or puncture in the sealed walls, injecting the compliant material 474 into space 472, and then sealing the hole or puncture (e.g., with an adhesive).

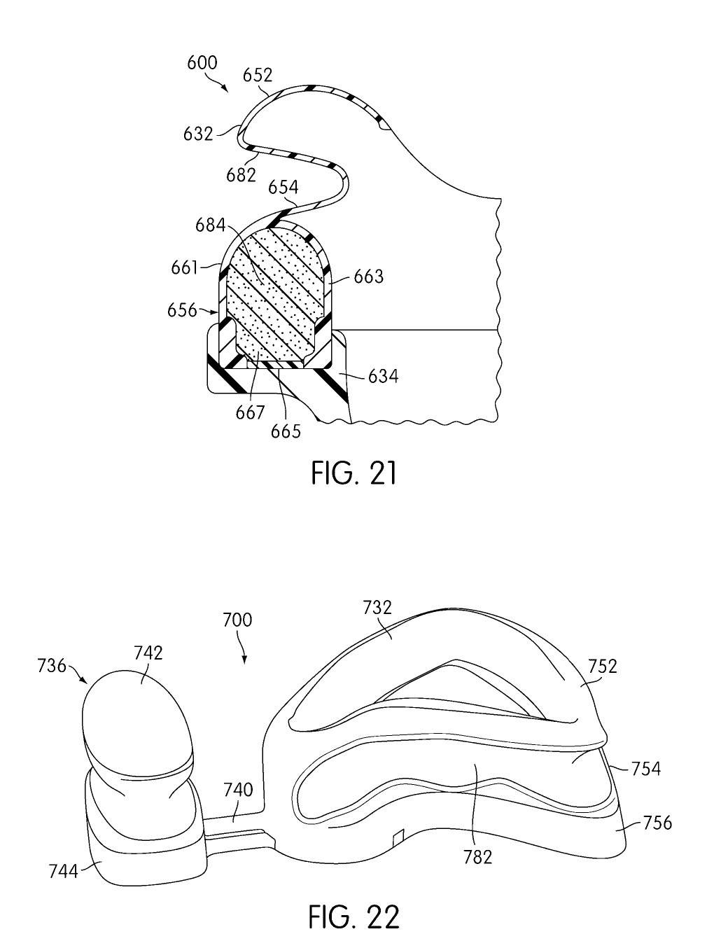

FIG. 21 illustrates an embodiment of a respiratory face mask 600 having a cushion 632, where the cushion 632 includes a pleat 682 formed about the portion of the cushion 632. The cushion 632 has a flap portion 652, a middle portion 654, and a connection portion 656. The middle portion 654 is adjacent to the flap portion 652, with the pleat 682 therebetween. The connection portion 656 of the cushion 632 may be attached to the shell 634 using any method, as discussed later. Each of the portions 652, 654, 656 and 682 are formed integrally from a resilient material, as may be the case with the prior embodiments. The connection portion 656 of this embodiment is shaped to define a space 667. For example, the connection portion 656 extending from a middle portion 654 of the cushion 632 bifurcates into an outer wall 661 and an inner wall 663. The outer and inner walls 661 and 663 are constructed and arranged to connect with each other by an interconnecting wall 665. The space 667 formed between the outer wall 661 and inner wall 663 is filled with a compliant material 684. In one embodiment, the compliant material 684, which is different from the resilient material of the cushion 632, may include a plurality of different layers of the material selected from the group consisting of gel, gas, liquid, foam, non cross-linked polymer, saline or combination thereof. The layer materials, if layers are employed, may be entirely different (such as silicone gel and water, in one embodiment, for example). In another embodiment, the compliant material 684 includes a plurality of layers of materials with different viscosities of the same material (e.g., two gels of different viscosities).

In this embodiment, the interconnecting wall 665 may be formed from the same resilient material as the cushion 632, and in one embodiment (not shown) may be integrally formed (e.g., as a flap) with one of the walls 661 or 663, or may alternatively be formed from a separate rigid material adhesively or otherwise connected to the walls 661 and 663. The interconnecting wall 665 may be connected to walls 661 and/or 663 either after or before the compliant material 684 is placed between walls 661 and 663. Where a rigid wall 665 is provided, this may facilitate the connection between the connecting portion 656 with the rigid shell 634. In one embodiment, wall 665 and shell 634 may be formed from the same rigid material.

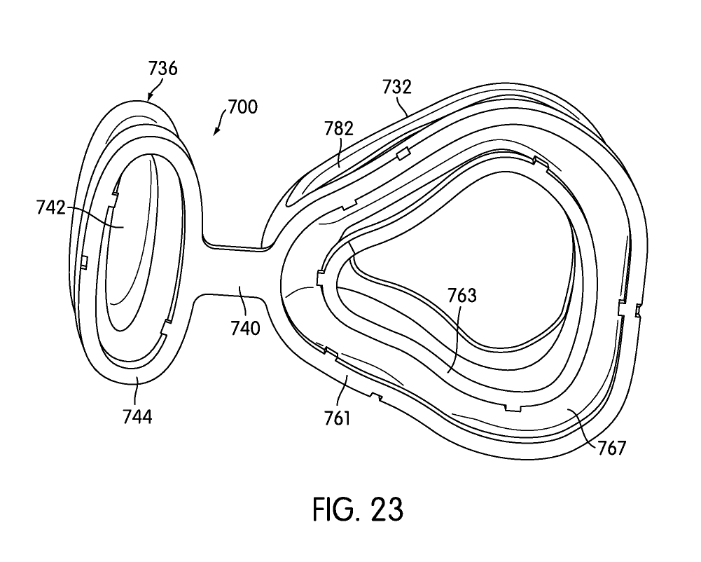

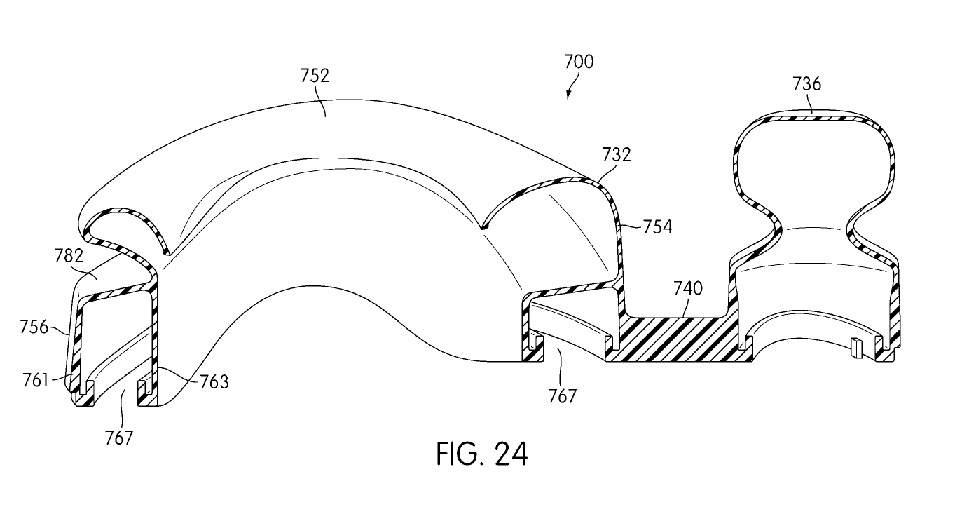

In another embodiment, as shown in FIGS. 22-25, a respiratory face mask 700 includes a cushion 732, a shell 734 and a forehead engaging structure 736. The forehead engaging structure 736 has a frame 740 that extends away from the shell 734. The frame 740 is attached to the shell 734 at one end and supports a pad 742 at the other end. A base 744 exists between the pad 742 and the frame 740 and may be integrally formed with, or separately formed and attached to the frame 740. The pad 742 is flexible (e.g., formed from one or more of the materials disclosed herein as being used for the cushions) so that it can conform to the particular shape of the user's forehead. The cushion 732 includes a discontinuous pleat 782 formed about the lower and side portions of the cushion 732.

The cushion 732 has a flap portion 752, a middle portion 754 and a connection portion 756. Specifically, in this embodiment, as shown, the flap portion 752 may transition immediately into the pleat 782, which in turn transitions immediately into the connection portion 756 towards the lower and side portions of cushion 732. Towards the upper (or apex) portion of the cushion, a small middle portion 754 may be provided instead of the pleat 782.

The connection portion 756 of the cushion 732 is attached to the shell 734 as discussed later. The connection portion 756 includes a resilient material (which may be integrally formed with flap portion 752) that is shaped to define a space 767 or at least a portion of a boundary around the space 767. For example, in one embodiment, the resilient material of the connection portion 756 extends from a middle portion 754 and/or pleat 782 and bifurcates into a first outer wall 761 and a second inner wall 763, to form the space 767 therewithin. The space 767 is surrounded by the first wall 761, by the second wall 763 and by a seal 725.

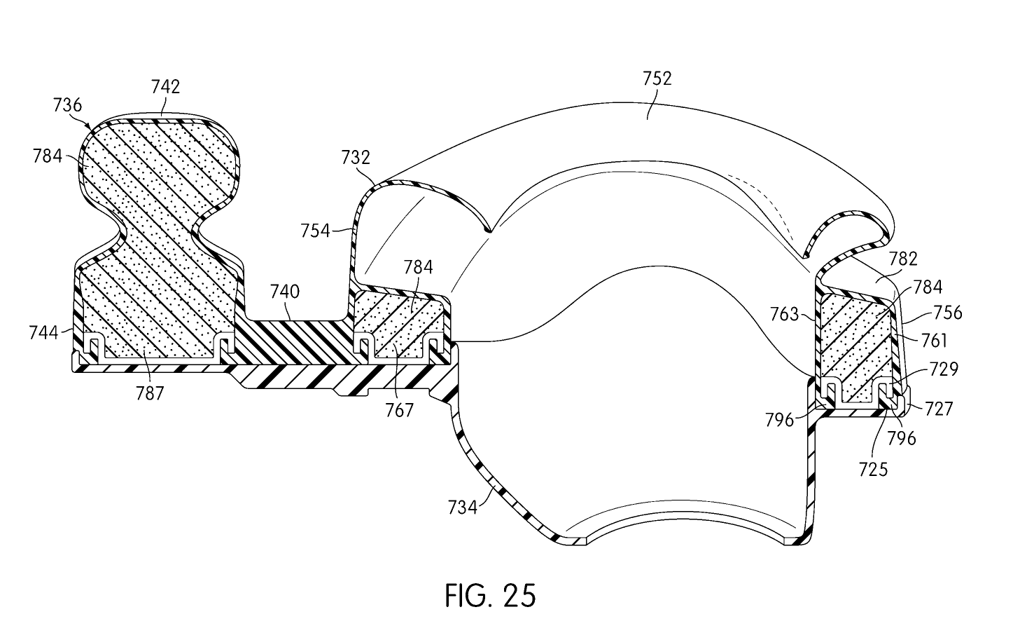

In one embodiment, as best seen in FIG. 25, the first wall 761 is generally shaped like an elbow and the second wall 763 is generally straight. Both the first wall 761 and the second wall 763 have a plurality of integral attachment tabs or members 796 that are turned inwardly and configured to connect the cushion 732 with the seal 725. The integral attachment members 796 on the second wall 763 and on the first wall 761 may have an L-shaped configuration as shown. The seal 725 has a generally u-shaped configuration with engagement members 729 at upper ends of the u-shaped configuration. In one embodiment, the engagement members 729 are inverted L-shaped legs 729. The inverted L-shaped legs 729 engage with the L-shaped lower surfaces of the second wall 763 and the first wall 761 respectively. The shell 734 has a U-shaped connecting portion 727 for receiving the walls 761, 763 and the seal structure 725 as shown. The seal 725 may be secured to the U-shaped connection portion 727 of the shell 734 using an adhesive connection, or a snap connection or a friction fit connection. At an upper portion of the mask, the u-shaped connecting portion 727 of the shell 734 transitions into the frame 740.

The space 767 in the connection portion 756 and the space 787 in the forehead engaging structure 736 are filled with a compliant material 784. In one embodiment, the compliant material 784 may include a plurality of different material layers selected from the compliant materials discussed previously.

In one embodiment, the compliant material 784 in the forehead engaging structure 736 is retained within the forehead engaging structure 736 by a lower, interconnecting sealing wall (not shown) adjacent or part of the frame 740. In one embodiment, the sealing wall that may be formed from the same resilient material as the forehead engaging structure 736. In one embodiment, the forehead engaging structure 736 comprises a bulbous support 742 made from a resilient material, which resilient material has an outer surface for contacting the user's forehead. The aforementioned interconnecting wall may be integrally formed (e.g., as a flap) with one of the walls of the support 742, or may alternatively be formed from a separate rigid material adhesively or otherwise connected to the walls of the forehead engaging structure 736. The interconnecting sealing wall may be connected to walls of the forehead engaging structure 736 either after or before the compliant material 784 is placed between walls of the forehead engaging structure 736. Where the interconnecting sealing wall is provided, this may facilitate the connection between the connecting portion 756 with the rigid shell 734. In one embodiment, the interconnecting wall and shell 734 may be formed from the same rigid material. In another embodiment, the compliant material 784 in the forehead engaging structure 736 is retained within the forehead engaging structure 736 by a seal (not shown) that may be formed from the same resilient material as the forehead engaging structure 736.

In one embodiment, the compliant material 784 in the connection portion 756 is retained within the space 767 by the aforementioned seal 725. The seal 725 is connected to the first wall 761 and the second wall 736 forming the space 767. Where the seal 725 is provided, this may facilitate the connection between the connecting portion 756 with the rigid shell 734. In one embodiment, the seal 725 and shell 734 may be formed from the same rigid material. Alternatively, the seal 725 may be formed from the same resilient material as the connection portion 756.

In one embodiment, the compliant material 784 disposed in the space 767 of the connection portion 756 and the connection portion 756 are continuous about the periphery of the cushion. In another embodiment, the compliant material 784 disposed in the space 767 of the connection portion 756 and the connection portion 756 are discontinuous about the periphery of the cushion.

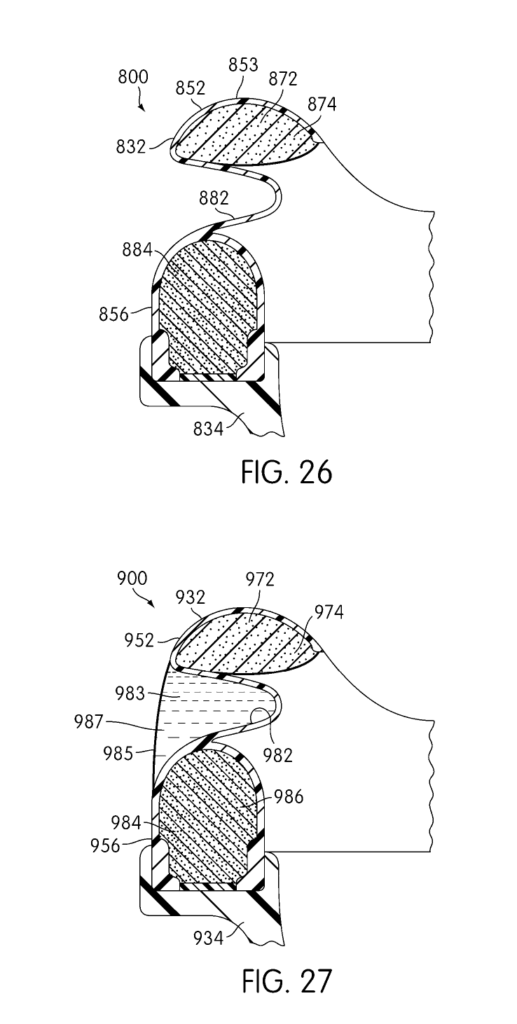

FIG. 26 illustrates an embodiment of a respiratory face mask 800, which includes a compliant material filled space in the flap portion as discussed above with respect to the respiratory face mask 500 shown in FIG. 19 and a space in the connection portion that is filled with the compliant material as discussed with respect to the respiratory face mask 600 shown in FIG. 21. Specifically, the mask 800 has a cushion 832 and a shell 834, where the cushion 832 includes a flap portion (or face contacting region) 852 that defines a space 872 behind a face contacting surface 853. The space 872 is constructed and arranged, as with the embodiment of FIG. 19, to receive a compliant material 874. A pleat 882 is formed about a portion of the cushion 832, and a connection portion 856 is provided with a space 884. In one embodiment, the space 872 includes a super soft silicone gel and the space 884 of the connection portion 856 includes a harder polyurethane gel. In one embodiment, the compliant material 884 includes a plurality of different material layers of the material selected from the compliant materials discussed previously. Any combination of compliant materials discussed above can be used in ether space 872 and 884.

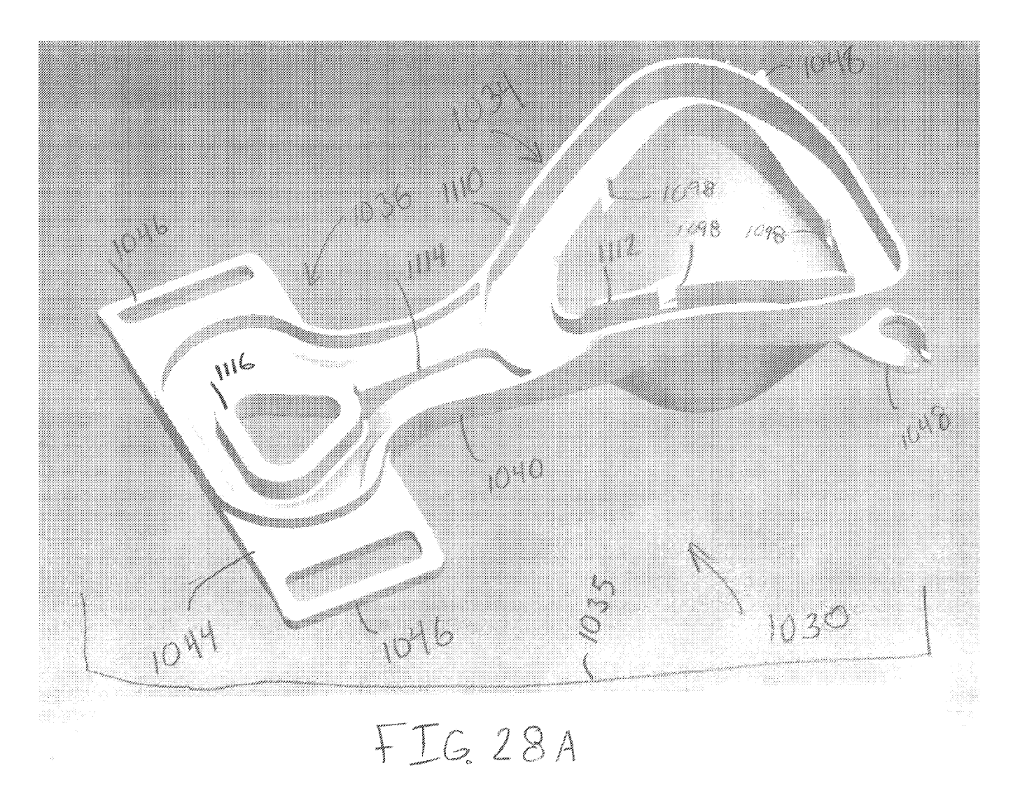

FIG. 27 illustrates another embodiment of a respiratory face mask 900. The mask 900 has a cushion 932 and a shell 934. The cushion 932 includes a flap (or face contacting) structure 952 that defines a space 972 for receiving a compliant material 974. A pleat 982 cooperates with a seal or wall 985 to define a space 987 filled with a compliant material 983 that is formed about the cushion 932. A connection portion 956 is provided with a space 984 filled with a compliant material 986 as discussed above with respect to FIG. 21.

The compliant materials 974, 983, and 986 can be different or the same as one another. In addition, any one of the compliant materials disclosed above can be used for any of the compliant materials 974, 983, and/or 986. In addition, any one of the spaces 972, 984 and/or 987 may be provided or filled with different layers of different types of compliant materials as discussed above.

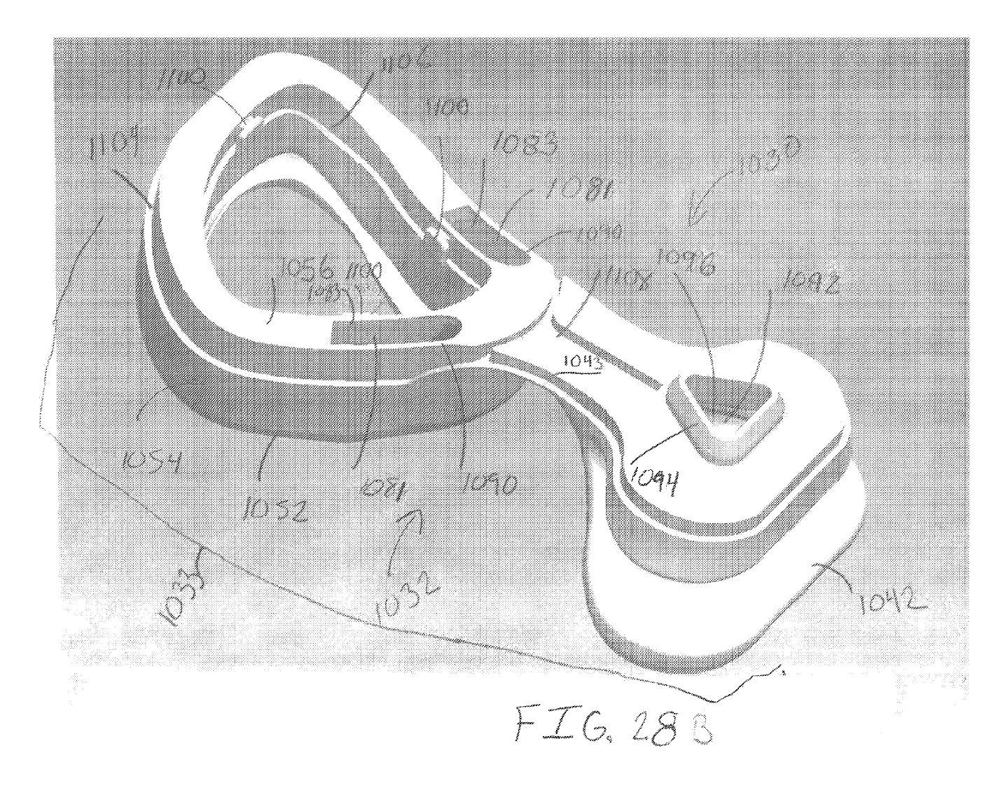

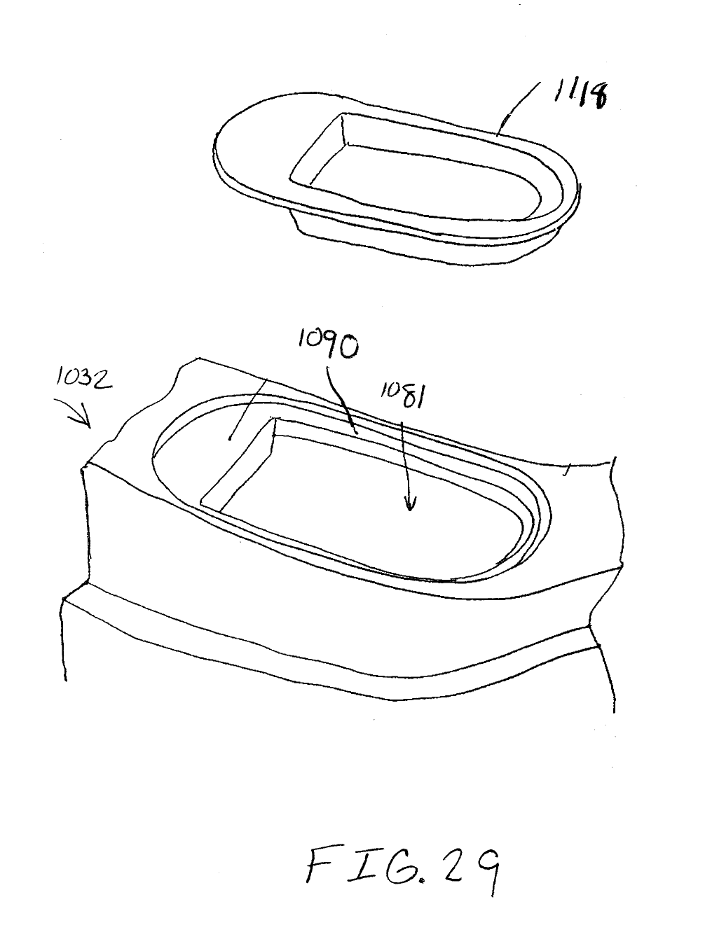

FIGS. 28A-29 depicts further embodiments of a respiratory mask 1030. Respiratory mask 1030 may generally include a cushion 1032 and a shell 1034 coupled to the cushion 1032. The cushion 1032 includes a flap portion 1052 formed from a resilient material; a mid portion 1054 adjacent to the flap portion 1052 formed from the resilient material; and a connection portion 1056 adjacent to the mid portion 1054 formed from the resilient material. Although this embodiment may include a pleat, as described above, the cushion 1032, shown in FIG. 28, has a space 1081 filled with a compliant material 1083. Rather than having a large open space, in this embodiment the space 1081 may be accessed through openings 1090. The space 1081 may be injected or otherwise filed with compliant material 1083. The mask 1030 further includes a forehead pad 1042 connected by a web 1043 to cushion 1032. The forehead pad 1042 includes a space 1092 which may be accessed by opening 1094 and filled with a compliant material 1096. Together the cushion 1032, pad 1042 and web 1043 forms a resilient assembly 1033.

The shell 1034 generally conforms to the shape of the cushion 1034. A frame 1040 extends from shell portion 1032 and supports a base 1044. The structural assembly (shell 1034, frame 1040, and base 1044) 1035 may be integrally formed together or manufactured separately and connected through a variety of means well known in the art. This assembly may be formed from a rigid plastic material, such as polycarbonate or any other plastic material as would be appreciated by one skilled in the art. The resilient assembly 1033 is connected to the structural assembly 1035 by grooves 1098 formed on the structural assembly 1035 and tabs 1100 formed on cushion 1032. To assist with coupling the resilient assembly 1033 and the structural assembly 1035 together, the resilient assembly 1033 includes a peripheral alignment groove 1104, an internal alignment groove 1106, and a central T-shaped alignment groove 1108. The structural assembly 1035 includes a corresponding peripheral wall 1110, an internal wall 1112, and a central T-shaped wall 1114.

Compliant materials 1083, 1096 may be isolated from one another. Alternately, space 1081 and space 1092 may be in communication with each other. In the event that spaces 1081, 1092 are in communication, compliant material 1083, 1096 may be injected through one or more of the openings 1090, 1094. Or, the spaces may be isolated relative to one another such that compliant materials having differing durometers can be used. The openings 1090, 1094 may be enclosed by the structural assembly 1035. Opening 1094 may be enclosed by an integral cap 1116 formed on the structural assembly 1035 which fits into or about opening 1094 as shown in FIG. 28A. Of course, openings 1090 may be similarly enclosed by a cap, not shown. Alternatively, as shown in FIG. 29, openings 1090 may be enclosed by a separate cap 1118 which fits into or about the opening. Similarly, opening 1094 may also be enclosed by a separate cap, not shown.

It should also be appreciated that for all of the embodiments, discussed above, each of the compliant material filled spaces may extend continuously about the mask, or alternatively extend only partially around the periphery of the mask. Although the figures disclose a particular configuration, one of ordinary skill in the art can best appreciate that the pleats, wall thickness and the compliant material containing spaces may be modified to address particular issues in various mask configurations such as full face masks, nasal masks, nasal-oral masks, or nasal pillows. In the event that a particular region is too rigid in the axial direction, the wall thickness could be varied, the depth of the flap could be varied, a pleat could be added and/or the amount of type of compliant material can be altered. In the event that a particular region experiences increased radial forces, the wall thickness could be increased, the length of the flaps could be decreased, pleats could be added, and/or amount or type of compliant material can be altered.

The respiratory mask as discussed in this invention fits over the user's nose. It is to be understood, however, that the present invention also contemplates a total face mask that accommodates substantially the entire facial area (including the nose, the mouth and the eyes) of the patient, an oral/nasal mask that accommodates only the mouth and the nose of a user, a full face mask that covers a majority of the user's face, or a patient interface that fits within the user's nares. The configuration of the mask may vary and is not limited to a particular size or configuration, as patients may range in age, size, and/or medical purpose so as to require appropriate selection from among a variety of different mask sizes and configurations as would be appreciated by one skilled in the art. As is conventional, the shell of the face mask may also preferably includes fastening devices, such as slots adapted to receive pivot members, which are connected to the headgear, and ears may extend from the base of the forehead support. Together, the ears and slots may secure the headgear to the respiratory mask.

The cushion of the respiratory mask may be attached to the shell in different methods as would be appreciated by one skilled in the art. For example, the cushion may be attached to the shell using an adhesive. Alternatively, the cushion may be attached by overmolding the cushion onto the shell. Of course, other methods of interconnecting the shell to the cushion may be contemplated without departing from the scope of the present invention. In one embodiment, the cushion is formed by injection molding process. The term “filled” as used herein is a generic term used to refer to a space that is completely filled or only partially filled with compliant material.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A mask assembly for providing gas to a patient, comprising:
a mask body having an opening for reception of the gas, the mask body including a seal structure for sealingly engaging with the face of the patient and surrounding at least the nose and mouth of the patient, the mask body having a connecting portion; and
a conduit releasably connected with the connecting portion of the mask body for delivering the gas to the patient through the opening, the conduit comprising a first connector portion which connects with the connecting portion, and a second connector portion constructed and arranged to connect with tubing, wherein the first connector portion comprises a plurality of recesses at an interface with the connecting portion to allow exhaled gas to escape therethrough.

2. The mask assembly according to claim 1, further comprising a breathing circuit interface connected with the mask body, and wherein the connecting portion is formed on the breathing circuit interface.

3. The mask assembly according to claim 2, wherein the breathing circuit interface is rotatably connected with the mask body.

4. The mask assembly according to claim 3, wherein the conduit is constructed and arranged to form a friction fit connection with the connecting portion.

5. The mask assembly according to claim 1, wherein the conduit is constructed and arranged to form a friction fit connection with the connecting portion.

6. The mask assembly according to claim 1, wherein the conduit comprises an inlet constructed and arranged to connect with tubing, an outlet constructed and arranged to connect with the connecting portion, a secondary inlet between the inlet and the outlet, the secondary inlet communicating the conduit with atmosphere and a valve that is movable between a first position sealing the inlet and a second position sealing the secondary inlet.

7. The mask assembly according to claim 6, wherein the valve comprises a flexible member that normally seals the inlet and is flexible upon application of pressurized gas through the inlet to move to the second position sealing the secondary inlet.

8. A mask assembly kit for providing gas to a patient, comprising:
a mask body having an opening for reception of the gas, the mask body including a seal structure for sealingly engaging with the face of the patient and surrounding at least the nose and mouth of the patient;
a first, valveless conduit; and
a second conduit containing a valve,
each of the conduits comprising a first connector portion which connects with a connecting portion associated with the mask body, and a second connector portion constructed and arranged to connect with tubing, wherein connecting portion of the mask body is constructed and arranged to be selectively attached to the first connector portion of either the first conduit or the second conduit.

9. The mask assembly kit according to claim 8, wherein each first connector portion of the conduits is constructed and arranged to form a friction fit connection with the connecting portion.

10. The mask assembly kit according to claim 9, further comprising a breathing circuit interface connected with the mask body and providing the connecting portion that connects the mask body with the selected conduit.

11. The mask assembly kit according to claim 10, wherein the breathing circuit interface forms a friction fit connected with the selected conduit.

12. The mask assembly kit according to claim 10, wherein the breathing circuit interface forms a rotatable connection with the mask body.

13. The mask assembly kit according to claim 11, wherein the second conduit comprises a plurality of recesses that provide gas communication between the patient and atmosphere at the friction fit connection between the second conduit and the breathing circuit interface.
